(19) United States
(12) Patent Application Publication
(10) Pub. No.: US 2018/0172644 A1
(43) Pub. Date: Jun. 21, 2018

(54) METHOD AND SYSTEM FOR ACOUSTICALLY SCANNING A SAMPLE

(71) Applicant: SOCPRA SCIENCES ET GÉNIE S.E.C., Sherbrooke (CA)

(72) Inventors: Julien Sylvestre, Chambly (CA); Remy Beland, Sherbrooke (CA)

(73) Assignee: SOCPRA SCIENCES ET GÉNIE S.E.C., Sherbrooke, QC (CA)

(21) Appl. No.: 15/736,031

(22) PCT Filed: Jun. 15, 2016
(86) PCT No.: PCT/IB2016/053551

§ 371 Date: Dec. 13, 2017

Related U.S. Application Data
(60) Provisional application No. 62/181,497, filed on Jun. 18, 2015.

(51) Int. Cl. G01N 29/28; G01N 29/06; G01N 29/22; G10K 11/35

(52) U.S. Cl. CPC G01N 29/28; G10K 11/357; G01N 29/221; G01N 29/0681

(57) ABSTRACT

An acoustic microscope for scanning a sample, comprising: a pulse transmitter for generating and propagating first acoustic pulses along a propagation direction; a rotatable mirror for deflecting the first acoustic pulses, the rotatable mirror being rotatable about a rotation axis being substantially orthogonal to the propagation direction; an acoustic lens for focusing the deflected first acoustic pulses in the sample and propagating second acoustic pulses reflected by the sample towards the rotatable mirror, the second acoustic pulses being deflected by the rotatable mirror; a pulse detector for detecting the deflected second acoustic pulses; a transmitter controller for controlling the pulse emitter and emitting each one of the first acoustic pulses as a function of a respective angular position of the rotatable mirror; and a mirror controller for rotating the rotatable mirror in order to scan the sample along a scan direction.

### TECHNICAL FIELD

The present invention relates to the field of acoustic microscopes, and more particularly to high scanning speed acoustic microscopes.

### BACKGROUND

An acoustic microscope or Acoustic Micro Imaging (AMI) system uses the amplitudes and times-of-arrival of acoustic pulses reflected off sample internal layers to non-destructively reconstruct a tri-dimensional image of the sample structure. The reflected pulses are generated at each material interface inside the sample. The amplitude of the reflected pulses, which is related to the acoustic impedance differences between layers, is used to assign different colors to pixels in the tri-dimensional image.

In microelectronic packaging, defects create important impedance differences, so that an acoustic microscope is considered as an efficient inspection tool. Times-of-arrival of the reflected pulses relate directly to the layer positions inside the sample and by appropriate time gating it is possible to image different layers.

Usually, the acoustic microscope needs to physically move the transducer head from one pixel to the next, according to a raster scan method, in order to acquire a 2D image. Typically, a usual acoustic microscope presents a maximum moving speed that is around 600 mm/s. Therefore, scanning a 20 mm×20 mm sample takes at least 60 seconds.

However, a long acquisition time limits the sampling possibilities in an industrial environment because of factors such as concomitant operator costs, increased cycle times, and important capital investments. Furthermore, the quality of the images is substantially low because it is usually not possible to implement complex signal processing algorithm due to the very long acquisition times. In addition, the motion of the scan head relative to the sample usually requires a liquid coupling medium, often water. Some devices are moisture-sensitive, and cannot be inspected by traditional acoustic microscopes.

Therefore, there is a need for an improved acoustic microscope.

### SUMMARY

According to a first broad aspect, there is provided an acoustic microscope for scanning a sample, comprising: a pulse transmitter for generating and propagating first acoustic pulses along a propagation direction; a rotatable mirror for deflecting the first acoustic pulses, the rotatable mirror being rotatable about a rotation axis being substantially orthogonal to the propagation direction; an acoustic lens for focusing the deflected first acoustic pulses in the sample and propagating second acoustic pulses reflected by the sample towards the rotatable mirror, the second acoustic pulses being deflected by the rotatable mirror; a pulse detector for detecting the deflected second acoustic pulses; a transmitter controller for controlling the pulse emitter and emitting each one of the first acoustic pulses as a function of a respective angular position of the rotatable mirror; and a mirror controller for rotating the rotatable mirror in order to scan the sample along a scan direction.

In one embodiment, the pulse generator and the pulse detector are positioned at different locations relative to the rotatable mirror.

In another embodiment, the pulse generator and the pulse detector are part of an acoustic transceiver, the pulse generator and the pulse detector being positioned substantially at a same location relative to the rotatable mirror.

In one embodiment, the acoustic microscope further comprises: a first delay block positioned between the pulse generator and the rotatable mirror; a second delay block positioned between the rotatable mirror and the pulse detector; and a third delay block positioned between the rotatable mirror and the acoustic lens.

In one embodiment, the acoustic microscope further comprises an acoustic impedance matching element between the acoustic lens and the sample.

In one embodiment, the mirror controller is adapted to rotate the rotatable mirror according a rotation direction.

In one embodiment, the mirror controller is adapted to oscillate the rotatable mirror between a first angular position and a second angular position.

In one embodiment, the rotatable mirror comprises a substantially planar reflecting face.

In one embodiment, the rotatable mirror comprises at least three reflecting faces forming a polygon.

In one embodiment, the acoustic microscope further comprises a frame enclosing the rotatable mirror, the frame further enclosing an acoustic impedance matching fluid.

In one embodiment, the acoustic impedance matching fluid is a metal alloy that is liquid at an operating temperature.

In one embodiment, the rotatable mirror comprises a rotatable cylinder having a cavity therein, the first acoustic pulses being reflected at an interface between the cavity and the rotatable cylinder.

In one embodiment, the cavity comprises vacuum.

In one embodiment, the cavity contains a material having a first acoustic impedance that is different from a second acoustic impedance of the rotatable cylinder.

In one embodiment, the rotatable cylinder is made of one of fused silica and quartz, and the cavity contains air.

In one embodiment, the rotatable mirror comprises a half-cylindrical body.

According to another broad aspect, there is provided an acoustic microscope for scanning a sample, comprising: an acoustic transceiver for generating and propagating first acoustic pulses along a propagation direction and detecting second acoustic pulses; a rotatable mirror for deflecting the first acoustic pulses, the rotatable mirror being rotatable about a rotation axis being substantially orthogonal to the propagation direction; an acoustic lens for focusing the deflected first acoustic pulses in the sample and propagating reflected acoustic pulses reflected by the sample towards the rotatable mirror, the reflected acoustic pulses being deflected by the rotatable mirror towards the acoustic transceiver to be detected thereby; a transmitter controller for controlling the acoustic transceiver and emitting each one of the first acoustic pulses as a function of a respective angular position of the rotatable mirror; and a mirror controller for rotating the rotatable mirror in order to scan the sample along a scan direction.

In one embodiment the acoustic microscope further comprises a first delay block positioned between the pulse generator and the rotatable mirror; a second delay block positioned between the rotatable mirror and the pulse detector; and a third delay block positioned between the rotatable mirror and the acoustic lens.

In one embodiment the acoustic microscope further comprises an acoustic impedance matching element between the acoustic lens and the sample.

According to a further broad aspect, there is provided a method for acoustically scanning a sample, comprising: successively generating a plurality of input acoustic pulses and propagating each input acoustic pulse towards a rotatable mirror along a propagation direction; rotating the rotatable mirror about a rotation axis being substantially orthogonal to the propagation direction, thereby deflecting each input acoustic pulse at a respective angular position for the rotatable mirror and obtaining a plurality of deflected acoustic pulses, said rotating allowing to scan a line of the sample; and for each deflected pulse: propagating the deflected input acoustic pulse towards a focusing lens; focusing the deflected input acoustic pulse in the sample; the acoustic lens collecting an output acoustic pulse reflected by the sample; propagating the output acoustic pulse towards the rotatable mirror, thereby deflecting the output acoustic pulse; and detecting the deflected output pulse at a pulse detector.

### BRIEF DESCRIPTION OF THE DRAWINGS

Further features and advantages of the present invention will become apparent from the following detailed description, taken in combination with the appended drawings, in which:

FIG. 1 is a block diagram illustrating an acoustic microscope comprising an acoustic pulse generator and a separate pulse detector, in accordance with an embodiment;

FIG. 2A is a block diagram illustrating a rotatable mirror comprising a rotatable cylinder provided with an internal cavity, in accordance with an embodiment;

FIG. 2 illustrates a rotatable mirror provided with a half-cylindrical shape, in accordance with an embodiment;

FIGS. 3A and 3B illustrates the propagation of acoustic pulses in the acoustic microscope of FIG. 1, in accordance with an embodiment;

FIG. 4 illustrates an acoustic microscope comprising two rotatable mirrors, in accordance with an embodiment;

FIG. 5 is a block diagram illustrating an acoustic microscope comprising a preamplifier, a filter, an amplifier, and a digitizer, in accordance with an embodiment;

FIG. 6 is a block diagram illustrating an acoustic microscope comprising an acoustic transducer and a rotatable mirror that rotates in a single direction, in accordance with an embodiment;

FIG. 7 is a block diagram illustrating an acoustic microscope comprising an acoustic transducer and an oscillating mirror, in accordance with an embodiment;

FIG. 8 is a block diagram illustrating an acoustic microscope comprising a hexagonal mirror, in accordance with an embodiment;

FIG. 9 is a block diagram illustrating an acoustic microscope comprising a frame in which an acoustic mirror surrounded by an impedance matching fluid is enclosed in a frame, in accordance with an embodiment;

FIGS. 10A and 10B schematically illustrate an F-theta acoustic lens and an F-tan(theta) acoustic lens, in accordance with an embodiment;

FIGS. 11A-11C each illustrate a respective lens configuration for an acoustic microscope, in accordance with an embodiment; and

FIG. 12 illustrates an exemplary acoustic pulse.

It will be noted that throughout the appended drawings, like features are identified by like reference numerals.

### DETAILED DESCRIPTION

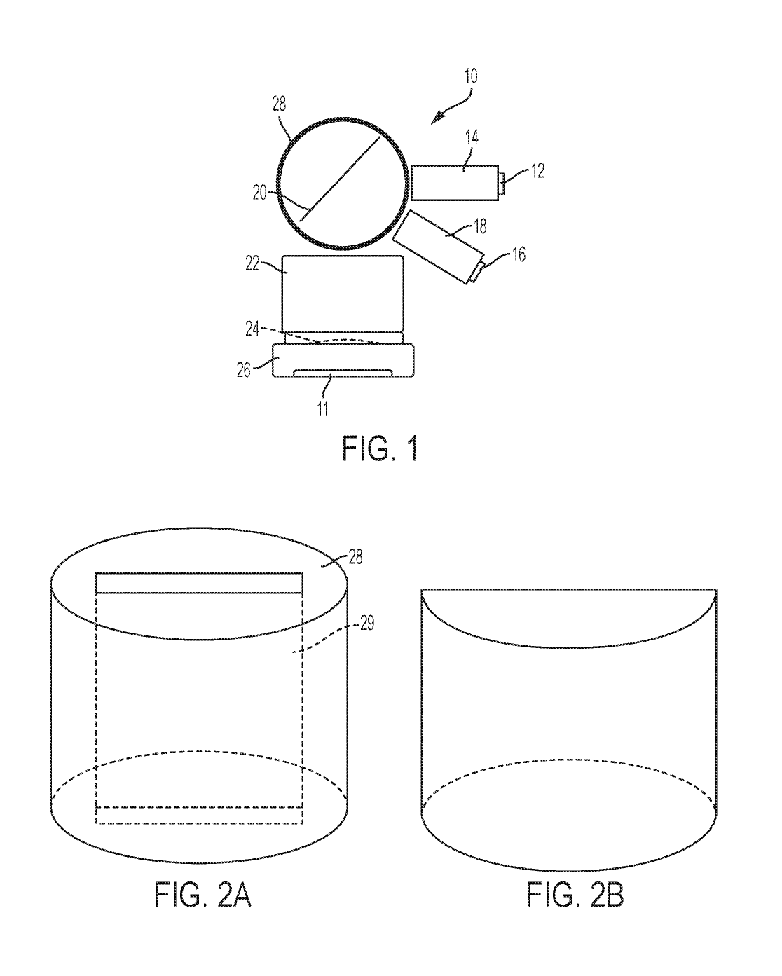

FIG. 1 illustrates one embodiment of an acoustic microscope or AMI system 10 for scanning a sample 11. The acoustic microscope 10 comprises an acoustic pulse generator 12, a first delay block 14, a pulse detector 16, a second delay block 18, a rotatable mirror 20, a third delay block 22, an acoustic lens 24, an acoustic coupling device 26, and a drive controller (not shown) for rotating the mirror 20.

The acoustic pulse generator 12 is adapted to generate and propagate acoustic pulses according to a propagation axis. For example, the acoustic pulse generator 12 may comprise a piezoceramic device such as a piezoceramic transducer and a high frequency pulse generator with a power amplifier to reach a desired high voltage excitation. The acoustic pulse generator 12 is positioned at a first position relative to the rotatable mirror 20 so that the propagation axis of the acoustic pulse generator 12 be orthogonal to the rotation axis of the rotatable mirror 20. The first delay block 14 is positioned between the acoustic pulse generator 12 and the rotatable mirror 20, and is adapted to propagate an acoustic pulse generated by the acoustic pulse generator 12 from the acoustic pulse generator 12 towards the rotatable mirror 20. The rotatable mirror 20 is positioned so that its rotation axis be substantially parallel to the focal plane of the acoustic lens 24.

The pulse detector 16 is adapted to detect acoustic pulses. For example, the pulse detector 16 may be a piezoceramic device. The pulse detector 16 is positioned at a second position relative to the rotatable mirror 20 so that the longitudinal axis of the pulse detector be coplanar with the propagation axis of the acoustic pulse generator 12. The second delay block 18 is positioned between the pulse detector 16 and the rotatable mirror 20, and is adapted to propagate an acoustic pulse deflected by the rotatable mirror 20 towards the pulse detector 16.

The third delay block 22 is positioned between the rotatable mirror 20 and the acoustic lens 24, and the acoustic coupling device 26 is positioned between the acoustic lens 24 and the sample 11. The acoustic lens 24 is designed so as to focus any acoustic pulse on the sample 11 independently of the position on the acoustic lens 24 at which the acoustic pulse reaches the acoustic lens 24 and independently of the incidence angle of the acoustic pulse. In one embodiment, the acoustic lens 24 is adapted to focus an incoming acoustic pulse on a plane that is parallel to the acoustic lens 24. The acoustic coupling device 26 is adapted to match the acoustic impedance between the acoustic lens 24 and the sample 11.

It should be understood that any adequate rotatable mirror 20 adapted to rotate and reflect at least partially acoustic pulses may be used.

In one embodiment, the rotatable mirror 20 comprises a rotatable cylinder 28 having a cavity 29 formed therein as illustrated in FIG. 2A. The rotatable cylinder 28 is made of a material having a first acoustic impedance and may be made of quartz, fused silica, or the like. In one embodiment, the first acoustic impedance of the rotatable cylinder 28 is chosen so as to be similar or even substantially identical to the acoustic impedance of the delay blocks 14, 18, and 22 in order to minimize the coupling losses between the rotatable cylinder 28 and the delay blocks 14, 18, and 22. In one embodiment, the rotatable cylinder 28 is made of the same material as the delay blocks 14, 18, and 22. In one embodiment, the cavity 29 extends along at least a portion of the longitudinal length of the rotatable cylinder 28 and intersects the rotation axis of the rotatable cylinder 18.

In one embodiment, vacuum is contained in the cavity 29 so that the acoustic impedance difference between vacuum and the rotatable cylinder 28 allows acoustic pulses to be at least partially reflected. In another embodiment, the cavity 29 is filled with a material having a second acoustic impedance that is different from the first acoustic impedance of the rotatable cylinder 28 so that acoustic pulses propagating in the rotatable cylinder be at least partially reflected at the interface between the rotatable cylinder 28 and the cavity 29. For example, the material to be contained in the cavity 29 may be chosen so that its acoustic impedance be much greater than the first acoustic impedance of the rotatable cylinder 28. In another example, the material to be contained in the cavity 29 may be chosen so that the first acoustic impedance of the rotatable cylinder 28 be much greater than the acoustic impedance fluid contained in the cavity.

In one embodiment, the material contained in the cavity 29 is air. In this case, the cavity 29 may extend partially through the rotatable cylinder 28 or entirely through the rotatable cylinder 28 along a given direction.

FIG. 2B illustrates an exemplary rotatable mirror having a half-cylindrical shape. The half-cylinder is made of a material having an acoustic impedance different from that of air. As a result, the acoustic pulses propagate within the half-cylinder before being at least partially reflected by the flat or planar surface of the half-cylinder due to the difference of acoustic impedance between the material of the half-cylinder and air. In one embodiment, the flat surface of the half-cylinder may be coated with a material having an acoustic impedance that is different from that of the material from which the half-cylinder is made.

The purpose of the first, second and third delay blocks 14, 18, and 22 is to increase the propagation time of the pulses within the acoustic microscope 10 in order to increase the rotation of the rotatable mirror 20 between the emission and the detection of the acoustic pulse so as to obtain a better separation of incoming pulses and reflected pulses. In one embodiment, the first, second and third delay blocks 14, 18, and 22 are made of a material having an acoustic impedance that closely matches that of the other elements such as the rotatable cylinder 28, the acoustic lens 24, the acoustic pulse generator 12, etc.

In one embodiment, the first delay block 14 is in physical contact with the acoustic pulse generator 12, the second delay block 18 is in physical contact with the pulse detector 16, the third delay block 22 is in physical contact with the acoustic lens 24, the acoustic lens 24 is in physical contact with the acoustic coupling device 26, and/or the acoustic coupling device 26 is in physical contact with the sample 11.

In one embodiment, the acoustic pulse generator 12 comprises a pulse emitter and a pulse function generator. The pulse function generator is adapted to generate an electrical pulse signal and the pulse emitter is adapted to convert the electrical pulse signal into an acoustic pulse. The pulse emitter may be a piezoceramic transducer for example. A controller (not shown) may be present in order to control the pulse function generator so as to control the characteristics and the time of emission of the acoustic pulses.

In one embodiment, the pulse detector 16 comprises an acoustic receiver and a pulse receptor. The acoustic receiver is adapted to convert an acoustic pulse into an analog electrical signal and the pulse receptor is adapted to digitize the analog electrical signal. The acoustic receiver may be a piezoceramic transducer.

In an embodiment in which the acoustic pulse generator 12 and the pulse detector 16 each comprises a same piezoceramic transducer, the first and second delay blocks 12 and 16 may be identical.

In one embodiment, the acoustic coupling device 26 comprises a frame that contains an acoustic coupling fluid. In one embodiment, the acoustic impedance of the acoustic fluid is similar to that of the frame in which it is contained, and may also be similar to that of the rotating cylinder 28. The acoustic fluid may be water, silicone oil, liquid gallium, or the like.

In one embodiment, the first, second, and/or third delay blocks 14, 18, 22 and/or the acoustic coupling device 26 may be omitted. In one embodiment, the acoustic microscope only comprises the acoustic pulse generator 12, the pulse detector 16, the rotatable mirror 20, the acoustic lens 24, and the drive controller for controlling the rotatable mirror 20.

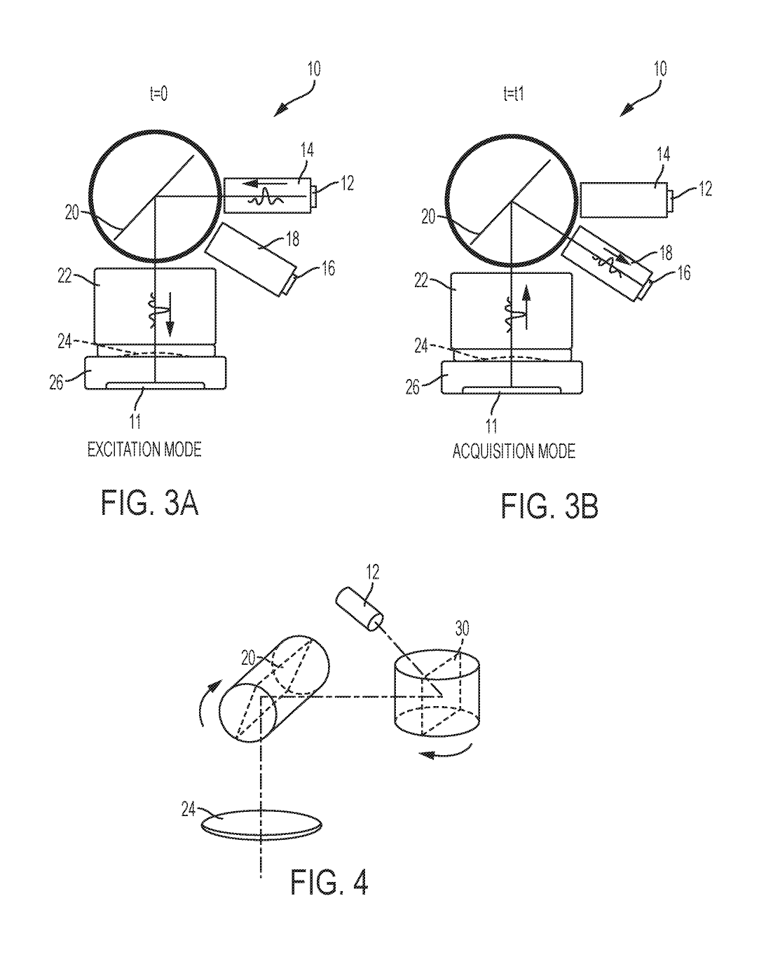

FIGS. 3A and 3B illustrate the acoustic microscope 10 while in operation. At time t0, the acoustic pulse generator 12 generates an acoustic pulse that propagates through the first delay block 14 before reaching the rotatable mirror 20 being at a first angular position. The rotatable mirror 20 deflects the incoming acoustic pulse towards the third delay block 22. The acoustic pulse then propagates through the third delay block 22 and reaches the acoustic lens 24. The sample 11 is positioned relative to the microscope 10 so that the focal plane of the acoustic lens 24 is inside the sample 11.

The acoustic lens 24 focuses the acoustic pulse inside the sample 11 and the acoustic pulse propagates through the acoustic coupling device 26 before reaching the sample 11. The acoustic pulse is at least partially reflected by structures such as interfaces between layers inside the sample 11, thereby generating a reflected acoustic pulse. The reflected acoustic pulse propagates through the acoustic coupling device 16, the acoustic lens 24, and the third delay block 22 before reaching the rotatable mirror 20. Between the time at which the incoming pulse generated by the acoustic pulse generator 12 is deflected by the mirror 20 and the time at which the pulse reflected by the sample 11 reaches the mirror 20, the mirror 20 is rotated from the first angular position to a second and different angular position so that the reflected pulse be deflected by the rotatable mirror 20 towards the pulse detector 16. After being deflected, the reflected acoustic pulse propagates through the second delay block 18 before reaching the pulse detector 16.

It should be understood that the drive controller rotates the rotatable mirror 20 between the time at which the acoustic pulse generated by the acoustic pulse generator 12 is deflected by the rotatable mirror 20 (which corresponds to the first angular position for the rotatable mirror 20) and the time at which the rotatable mirror 20 deflects the reflected acoustic pulse (which corresponds to the second angular position for the rotatable mirror 20). The first angular position of the mirror 20 is chosen so as to deflect the incoming acoustic pulse generated by the acoustic pulse generator 12 towards the sample 11 and the second angular position of the rotatable mirror 20 is chosen so as to deflect the acoustic pulse reflected by the sample 11 towards the pulse detector 16. In one embodiment, the drive controller is adapted to rotate the rotatable mirror in a step-by-step manner so that the angular position of the rotatable mirror 20 be iteratively changed. In another embodiment, the drive controller is adapted to substantially continuously rotate the rotatable mirror 20. In this case, the time required for rotating the rotatable mirror 20 between the first and second angular positions (which is equivalent to the rotation speed of the rotatable mirror 20) is chosen as a function of the time required for the incoming acoustic pulse to propagate from the rotatable mirror 20 to the sample 11 and the time required for the reflected acoustic pulse to propagate from the sample 11 to the rotatable mirror 20. In a further embodiment, the drive controller is adapted to oscillate the rotatable mirror between two extreme angular positions. In this case, the rotatable mirror 20 is rotated in a first angular direction until it reaches a first extreme angular position. The rotatable mirror 20 is then rotated in the angular direction opposite to the first angular direction until it reaches the second extreme angular position, etc.

In an embodiment in which the sample 11 comprises several layers, several acoustic pulses may be reflected by the sample 11. For example, the sample 11 may comprise two layers. In this case, the incoming acoustic pulse may be partially reflected by the top surface of the sample, thereby generating a first reflected acoustic pulse. Then the incoming acoustic pulse is also partially reflected by the interface between the two layers, thereby generating a second reflected acoustic pulse. Finally, the incoming acoustic pulse is reflected by the bottom surface of the sample 11, thereby generating a third reflected acoustic pulse. The three reflected acoustic pulses are then detected by the pulse detector 16.

In one embodiment, the surface area of the pulse detector 16 and the rotation speed of the rotatable mirror 20 are chosen so as to select a given analysis depth for the sample. For example, if the surface area of the pulse detector 16 is small and the rotation speed of the rotatable mirror 20 is great, then only acoustic pulses reflected by structures located in the sample within a certain depth reach the surface area of the pulse detector 16.

By following the procedure illustrated by FIGS. 3A and 3B, i.e. by generating a single acoustic pulse and collecting the reflected acoustic pulse(s), the acoustic microscope 10 allows for scanning a single and first point of the sample 11. In order to scan a line of the sample 11, multiple acoustic pulses are successively generated by the acoustic pulse generator 12 while the rotatable mirror 20 is rotated. For each angular position taken by the rotatable mirror 20 while it is rotated, a respective acoustic pulse generated by the acoustic pulse generator 12 is deflected by the rotatable mirror 20 towards a respective position on the sample along a line thereof. Therefore, it is possible to scan the surface of the sample 11 according a first dimension, i.e. a line, by rotating the rotatable mirror while successively generating acoustic pulses.

In order to scan the surface of the sample 11 in a second dimension, several techniques may be used.

In one embodiment, the relative position between the acoustic microscope 10 and the sample 11 may be varied. In one embodiment, a translation along a translation axis parallel to the rotation axis of the rotatable mirror 20 may be applied to vary the relative position between the acoustic microscope 10 and the sample 11. For example, the acoustic microscope 10 may be translated relative to the sample 11 in a direction orthogonal to the line previously scanned. In another example, the sample 11 may be translated relative to the acoustic microscope 10 in a direction orthogonal to the line previously scanned. The sample 11 is then scanned line by line and the scanned lines are parallel to each other.

In another embodiment, a rotation about an axis orthogonal to the top surface of the sample 11 may be applied to vary the relative angular position between the acoustic microscope 10 and the sample 11. For example, the acoustic microscope 10 may be rotated about a rotation axis orthogonal to the sample 11 while the position of the sample 11 remains unchanged. In another example, the sample 11 may be rotated about a rotation axis orthogonal thereto while the position of the acoustic microscope 10 remains unchanged. In this case, the sample 11 is scanned line-by-line and the lines intersect each other at an intersection point by which the rotation axis passes.

In a further embodiment, the acoustic pulse generator 12 and the acoustic pulse detector 16 are translated relative to the rotatable mirror 20 along a translation axis parallel to the rotation axis of the rotatable mirror 20 in order to scan the sample 11. It should be understood that the first and second delay blocks 14 and 18, if any, are also translated. The acoustic pulse generator 12 and the acoustic pulse detector 16 are translated along the translation axis. By iteratively translating the acoustic pulse generator 12 and the acoustic pulse detector 16, the sample 11 is scanned line-by-line and the scanned lines are parallel to each other.

In still another embodiment, the assembly comprising the acoustic pulse generator 12, the acoustic pulse detector 16, and the rotatable mirror 20 and the first and second delay blocks, if any, rotates about a rotation axis orthogonal to the top surface of the sample 11 in order to scan the sample 11. In this case, the sample 11 is scanned line-by-line and the scanned lines intersect at an intersection point by which the rotation axis passes.

In another embodiment, the acoustic microscope further comprises a second rotatable mirror as illustrated in FIG. 4. It should be understood that some elements of the acoustic microscope such as the pulse detector and the block delays are omitted from FIG. 4. As illustrated in FIG. 4, a second rotatable mirror 30 is positioned between the acoustic pulse generator 12 and the first rotatable mirror 20. The rotation axis of the second rotatable mirror 30 is substantially orthogonal to that of the first rotatable mirror 20. It is possible to scan a line of a sample extending along or being parallel to a first axis by rotating the first rotatable mirror 20. By rotating the second rotatable mirror 30, it is possible to scan a second line of the sample, the second line being substantially orthogonal to the first line. Therefore, the whole sample may be scanned by rotating the first and second rotatable mirrors 20 and 30.

In one embodiment the acoustic microscope 10 further comprises an optical encoder (not shown) to measure the angular position of the rotatable mirror 20 in order to synchronize the emission of acoustic pulses with the position of the rotatable mirror 20. While not illustrated in the figures, the acoustic microscope 10 also comprises a controller for controlling the acoustic pulse generator 10. This controller is adapted to control the characteristics of the emitted acoustic pulses such as their waveform, their amplitude, their frequency, and/or the like. The controller is further adapted to determine the time points at which acoustic pulses are to be emitted. The time points are determined as a function of the angular position of the rotatable mirror 20 which is measured by the optical encoder. For a given position of the acoustic pulse generator 12 relative to the rotatable mirror 20, the position of the scanned point of the sample 11 along the scanned line can be determined from the angular position of the rotatable mirror 20 since for any position along a given scanned line there is a unique corresponding angular position for the rotatable mirror 20. By knowing the position of the scanned point, it is then possible to reconstruct an image of the sample 11.

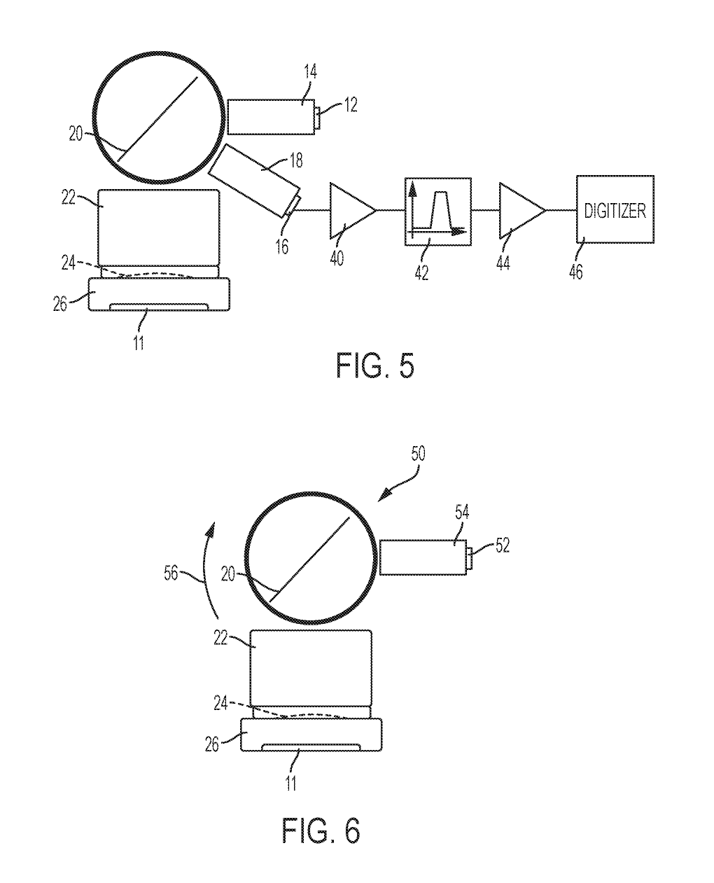

In one embodiment, the acoustic microscope 10 further comprises a preamplifier 40, a filter 42, an amplifier 44, and a digitizer 46, as illustrated in FIG. 5. The preamplifier 40 is used to increase the amplitude of the voltage extrema in the receiver signal. The filter 42 is used to attenuate or amplify certain frequency components of the signal. The amplifier 44 further adapts the voltage extrema of the signal so that they are within the dynamical range of the digitizer 46. The digitizer 46 converts the analog signal to a digital signal that can be processed by a computer.

While FIGS. 1, 3A, 3B, and 5 illustrate an acoustic microscope 10 comprising an acoustic pulse generator 12 and a separate acoustic pulse detector 16 located at different positions, FIG. 6 illustrates an acoustic microscope 50 that comprises an acoustic pulse transceiver 52 adapted to both generate acoustic pulses and detect acoustic pulses. The acoustic microscope 50 further comprises a delay block 54, a rotatable mirror 20, a delay block 22, an acoustic lens 24, and an acoustic coupling device 26. The delay block 54 is positioned between the acoustic pulse transceiver 52 and the rotatable mirror 20. In one embodiment, the delay block 54 abuts against the acoustic pulse generator 52 so as to be in physical contact with the acoustic pulse generator 52.

The acoustic microscope 50 operates in a similar manner as the acoustic microscope 10 except that the acoustic pulses are detected by the acoustic pulse generator, i.e. the acoustic pulse transceiver 52. In this case, once a pulse has been emitted by the acoustic pulse transceiver 52, the rotation of the rotatable mirror 20 may be stopped until the pulse reflected by the sample 11 be deflected by the rotatable mirror 20. The angular position of the rotatable mirror 20 may then be changed and a further acoustic pulse may be generated to scan another point of the sample 11. In another embodiment, the rotatable mirror 20 may be substantially continuously rotated during the generation and detection of acoustic pulses. In this case, the rotation speed of the rotatable mirror 20 is adequately chosen as a function of the time taken by the emitted pulse to reach the sample 11 and the time taken by the reflected pulse to reach the rotatable mirror 20. By adequately choosing the rotation speed of the rotatable mirror 20, the angular displacement of the rotatable mirror 20 is small enough to allow the reflected pulse to be detected by the acoustic transceiver 52.

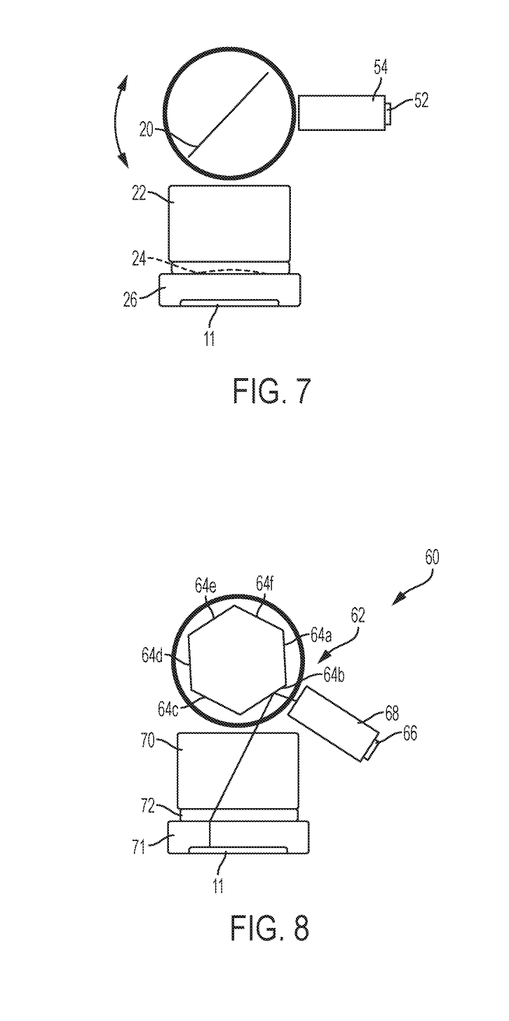

While the rotatable mirror 20 is rotated in a single rotation direction illustrated by arrow 56, FIG. 7 illustrates one embodiment in which the rotatable mirror 20 oscillates between two extreme angular positions. In this case, a first line of the sample 11 may be scanned by rotating the rotatable mirror 20 from the first extreme angular position to the second extreme angular position. Then a second line of the sample 11 may be scanned by rotating the rotatable mirror 20 from the second extreme angular position to the first extreme angular position.

While the acoustic microscopes 10 and 50 each comprise a planar rotatable minor, it should be understood that the rotatable minor may have any adequate shape. For example, the rotatable acoustic mirror may have a polygonal shape. In one example, the rotatable mirror may have a triangular shape and be formed of three acoustic reflecting plates arranged to form a triangle. FIG. 8 illustrates one embodiment of an acoustic microscope 60 which comprises a hexagonal rotatable mirror 62. The hexagonal mirror 62 comprises six acoustic reflecting plates 64a-64f arranged so as to form a hexagon. The rotation axis of the hexagonal mirror 62 passes by the center of the hexagon formed by the plates 64a-64f The acoustic microscope 60 further comprises an acoustic pulse generator 66 and a first delay block 68 secured to the acoustic pulse generator 66. The acoustic microscope 60 also comprises a second delay block 70, an acoustic lens 72, and an acoustic coupling device 74.

Each plate 64a-64f of the hexagonal minor 62 is adapted to scan a line of the sample 11. Therefore, six different lines of the sample 11 may be scanned a 360° rotation of the hexagonal mirror 62.

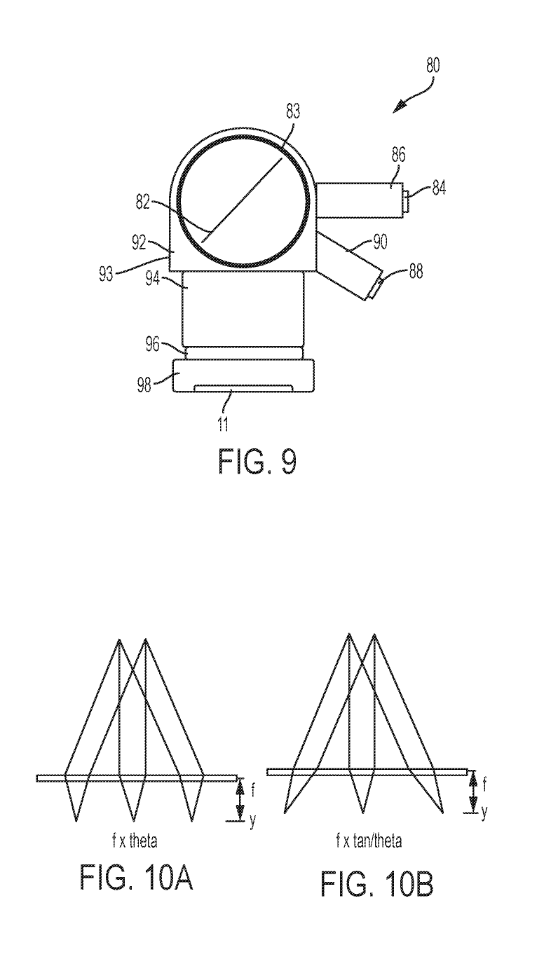

FIG. 9 illustrates one embodiment of an acoustic microscope 80 in which a rotatable mirror 82 inserted into a cylinder 83 that is surrounded by an acoustic impedance matching fluid 92 such as water, silicon oil or liquid gallium. The acoustic microscope 80 further comprises an acoustic pulse generator 84, a first delay block 86, an acoustic pulse detector 88, a second delay block 90, a frame 93 for enclosing the acoustic impedance matching fluid 92 and the cylinder 83, a third delay block 94, an acoustic lens 96, and an acoustic coupling device 98. The cylinder 83 comprising the rotatable mirror 82 is enclosed within the frame 93 and the frame 93 is filled with the acoustic impedance matching fluid 92 so that the cylinder 83 be surrounded by the acoustic impedance matching fluid 92. The first delay block 86 is in physical contact with the acoustic pulse generator 84 at one end and with the frame 90 at the other end. Similarly, the second delay block 90 is in physical contact with the acoustic pulse detector 88 at one end and with the frame 92 at the other end.

It should be understood that the acoustic impedance matching fluid 92 and the acoustic coupling device 98 are used for reducing coupling losses.

As described above, the acoustic length is shaped and sized so that any acoustic pulse wave incident on its face facing the rotatable mirror be focused on a plane substantially parallel to the symmetry plane of the acoustic lens independently of the incident angle and the position at which the acoustic pulse wave reaches the acoustic lens. The distance between the focusing plane and the acoustic lens corresponds to the focus length of the acoustic length. Such an acoustic lens is referred to as an acoustic flat field scanning lens.

FIGS. 10A and 10B schematically illustrate two different types of acoustic flat field scanning lens that may be used in the present acoustic microscope.

FIG. 10A illustrates an F-theta lens adapted to focus an acoustic pulse wave incident thereon on a point located to the perpendicular of the center of the acoustic pulse wave. FIG. 10B illustrates an F-tan(theta) lens adapted to focus an acoustic pulse wave incident thereon on a point that is not located to the perpendicular of the center of the acoustic pulse wave. As a result, an F-theta lens and an F-tan(theta) lens focus an acoustic pulse wave on a plane located at the focal length f of the lens but at a different lateral position on the plane.

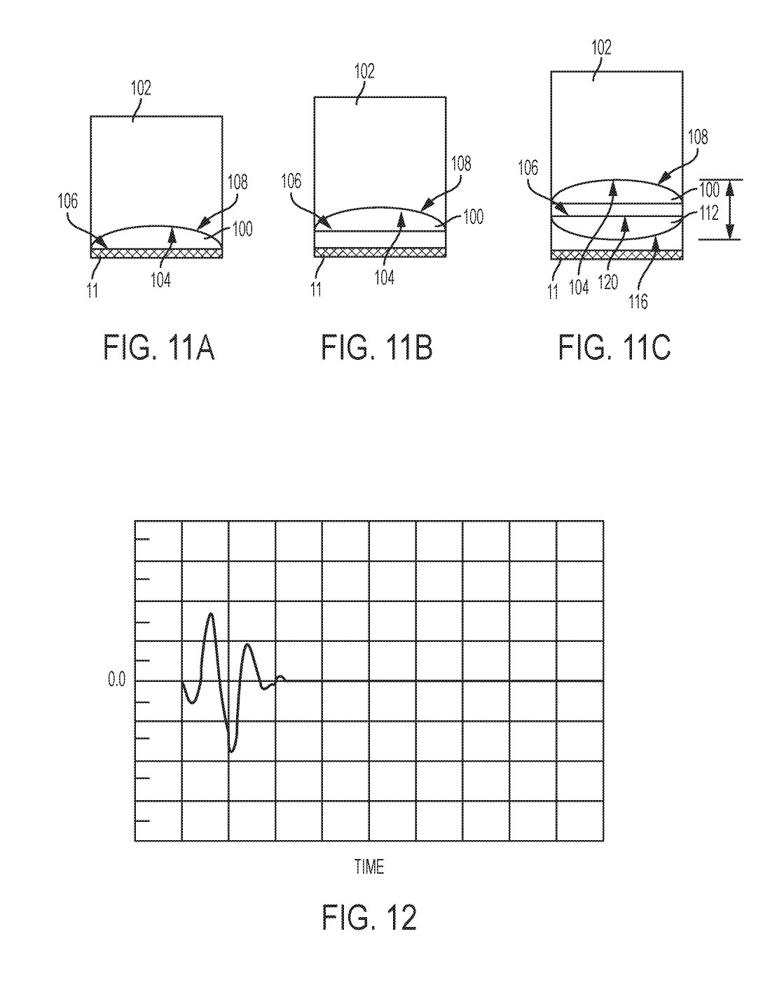

FIGS. 11A-11C each illustrate different acoustic lens configurations. In the lens configuration illustrated in FIG. 11A, a lens 100 is inserted between a delay block or tube 102 and a sample 11. The acoustic lens 100 extends between a convex face 104 that faces the delay tube 10 and a flat face 106 that faces the sample 11. The delay tube 102 comprises a concave face 108 that matches the convex face 104 of the acoustic lens 100. The convex face 106 of the acoustic lens 100 abuts against the concave face 108 of the delay tube 102 so that the acoustic lens 100 be in physical contact with the delay tube 102. In the illustrated embodiment, the flat face 106 of the acoustic lens 100 abuts against the sample 11.

While in the embodiment illustrated in FIG. 11A the acoustic lens 100 is in physical contact with the sample 11, FIG. 11B illustrates a configuration in which the acoustic lens 100 is spaced apart from the sample 11 so that a gap of air exists between the sample 11 and the acoustic lens 100.

FIG. 11C illustrates a configuration in which two acoustic lenses 100 and 112 are used for focusing acoustic pulses on the sample 11. The acoustic lenses 100 and 112 each extends between a convex face 104 and 116, respectively, and a flat face 106 and 120, respectively.

The acoustic lens 100 is positioned relative to the delay tube 102 so that the convex face 104 of the acoustic lens 100 abuts against the matching concave face 108 of the delay tube 102. The second acoustic lens 112 is spaced apart from the first acoustic lens 100 so that the flat face 106 of the first acoustic lens 100 faces the flat face 120 of the second acoustic lens 112. As a result, the convex face 116 of the second acoustic lens 112 faces the sample 11. In this illustrated embodiment, the sample 11 is spaced apart from the second acoustic lens 112.

In one embodiment, the above-described acoustic microscope presents fast scanning abilities. For example, a line of a sample may be scanned in less than 15 msec and an image of a whole sample may be acquired in less than 1 sec. In one embodiment, the acoustic microscope may scan 1000 sample lines in less than 1 sec, to form a one-megapixel image in less than one second.

In an embodiment in which the acoustic microscope comprises two rotatable mirrors, the usual need to precisely and rapidly move the scanning head over the sample to form an image is eliminated.

In one embodiment, the acoustic mirror(s), the delay block(s) and/or the acoustic lens are made of quartz, fused silica, or the like.

In one embodiment, the sample is positioned in a tank filled with water in order to be scanned. The water allows matching the acoustic impedance of the sample.

In one embodiment, an acoustic impedance matching layer may be inserted at any interface within the acoustic microscope in order to reduce coupling losses. For example, an acoustic impedance matching layer may be inserted between the acoustic pulse generator 12 and the first delay block 14, between the pulse detector 16 ad the second delay block 18, between the third delay block 22 and the acoustic lens 24, etc.

In one embodiment, the present acoustic microscope is simple to use and may help reducing training time for operators in addition to reducing the operation times.

In one embodiment, the present microscope may help reducing the cost related to sample inspection. Large acquisition times increase the cost of sample acoustic inspection, and reduce the use of acoustic microscopes in industrial environments. The present microscope allows reducing the time required for scanning a sample and therefore reducing the cost related to sample inspection.

In one embodiment, the present acoustic microscope offers a better sensitivity in comparison to usual acoustic microscopes. With usual acoustic microscopes, it is usually not possible to implement complex signal processing algorithms due to the very long acquisition times. Using the present acoustic microscope that presents a fast time acquisition, it is possible to develop advanced image processing software to increase the sensitivity by combining multiple images acquired under slightly different conditions (e.g. noise averaging, super-resolution imaging, etc.).

In one embodiment, the acoustic pulse generated by the acoustic pulse generator 12 is as short as possible. For example, the pulse can be a few cycles of a sinusoidal signal with a mostly Gaussian envelope. FIG. 12 illustrates an exemplary acoustic pulse.

The embodiments of the invention described above are intended to be exemplary only. The scope of the invention is therefore intended to be limited solely by the scope of the appended claims.

I claim:

1. An acoustic microscope for scanning a sample, comprising:
a pulse transmitter for generating and propagating first acoustic pulses along a propagation direction;
a rotatable mirror for deflecting the first acoustic pulses, the rotatable mirror being rotatable about a rotation axis being substantially orthogonal to the propagation direction;
an acoustic lens for focusing the deflected first acoustic pulses in the sample and propagating second acoustic pulses reflected by the sample towards the rotatable mirror, the second acoustic pulses being deflected by the rotatable mirror;
a pulse detector for detecting the deflected second acoustic pulses;
a transmitter controller for controlling the pulse emitter and emitting each one of the first acoustic pulses as a function of a respective angular position of the rotatable mirror; and
a mirror controller for rotating the rotatable mirror in order to scan the sample along a scan direction.

2. The acoustic microscope of claim 1, wherein the pulse generator and the pulse detector are positioned at different locations relative to the rotatable mirror.

3. The acoustic microscope of claim 1, wherein the pulse generator and the pulse detector are part of an acoustic transceiver, the pulse generator and the pulse detector being positioned substantially at a same location relative to the rotatable mirror.

4. The acoustic microscope of claim 1, further comprising:
a first delay block positioned between the pulse generator and the rotatable mirror;
a second delay block positioned between the rotatable mirror and the pulse detector; and
a third delay block positioned between the rotatable mirror and the acoustic lens.

5. The acoustic microscope of claim 1, further comprising an acoustic impedance matching element between the acoustic lens and the sample.

6. The acoustic microscope of claim 1, wherein the mirror controller is adapted to rotate the rotatable mirror according a rotation direction.

7. The acoustic microscope of claim 1, wherein the mirror controller is adapted to oscillate the rotatable mirror between a first angular position and a second angular position.

8. The acoustic microscope of claim 1, wherein the rotatable mirror comprises a substantially planar reflecting face.

9. The acoustic microscope of claim 1, wherein the rotatable mirror comprises at least three reflecting faces forming a polygon.

10. The acoustic microscope of claim 1, further comprising a frame enclosing the rotatable mirror, the frame further enclosing an acoustic impedance matching fluid.

11. The acoustic microscope of claim 10, wherein the acoustic impedance matching fluid is a metal alloy that is liquid at an operating temperature.

12. The acoustic microscope of claim 1, wherein the rotatable mirror comprises a rotatable cylinder having a cavity therein, the first acoustic pulses being reflected at an interface between the cavity and the rotatable cylinder.

13. The acoustic microscope of claim 12, wherein the cavity comprises vacuum.

14. The acoustic microscope of claim 12, wherein the cavity contains a material having a first acoustic impedance that is different from a second acoustic impedance of the rotatable cylinder.

15. The acoustic microscope of claim 14, wherein the rotatable cylinder is made of one of fused silica and quartz, and the cavity contains air.

16. The acoustic microscope of claim 1, wherein the rotatable mirror comprises a half-cylindrical body.

17. An acoustic microscope for scanning a sample, comprising:
an acoustic transceiver for generating and propagating first acoustic pulses along a propagation direction and detecting second acoustic pulses;
a rotatable mirror for deflecting the first acoustic pulses, the rotatable mirror being rotatable about a rotation axis being substantially orthogonal to the propagation direction;
an acoustic lens for focusing the deflected first acoustic pulses in the sample and propagating reflected acoustic pulses reflected by the sample towards the rotatable minor, the reflected acoustic pulses being deflected by the rotatable minor towards the acoustic transceiver to be detected thereby;
a transmitter controller for controlling the acoustic transceiver and emitting each one of the first acoustic pulses as a function of a respective angular position of the rotatable mirror; and
a mirror controller for rotating the rotatable mirror in order to scan the sample along a scan direction.

18. The acoustic microscope of claim 17, further comprising:
a first delay block positioned between the pulse generator and the rotatable mirror;
a second delay block positioned between the rotatable mirror and the pulse detector; and
a third delay block positioned between the rotatable mirror and the acoustic lens.

19. The acoustic microscope of claim 17, further comprising an acoustic impedance matching element between the acoustic lens and the sample.

20. A method for acoustically scanning a sample, comprising:
successively generating a plurality of input acoustic pulses and propagating each input acoustic pulse towards a rotatable mirror along a propagation direction;
rotating the rotatable mirror about a rotation axis being substantially orthogonal to the propagation direction, thereby deflecting each input acoustic pulse at a respective angular position for the rotatable mirror and obtaining a plurality of deflected acoustic pulses, said rotating allowing to scan a line of the sample; and
for each deflected pulse:
propagating the deflected input acoustic pulse towards a focusing lens;
focusing the deflected input acoustic pulse in the sample;
the acoustic lens collecting an output acoustic pulse reflected by the sample;
propagating the output acoustic pulse towards the rotatable mirror, thereby deflecting the output acoustic pulse; and
detecting the deflected output pulse at a pulse detector.
